(19) United States
(12) Patent Application Publication
(10) Pub. No.: US 2017/0046749 A1
(43) Pub. Date: Feb. 16, 2017

(54) ONE-CLICK PROMOTIONAL ADVERTISING

(71) Applicants: Venkateswarlu Kolluri, Shrewsbury, MA (US); Alden DoRosario, South Grafton, MA (US)

(72) Inventors: Venkateswarlu Kolluri, Shrewsbury, MA (US); Alden DoRosario, South Grafton, MA (US)

(21) Appl. No.: 15/211,129

(22) Filed: Jul. 15, 2016

Related U.S. Application Data
(60) Provisional application No. 62/199,009, filed on Jul. 30, 2015.
(60) Provisional application No. 62/232,635, filed on Sep. 25, 2015.
(60) Provisional application No. 62/311,186, filed on Mar. 21, 2016.

(51) Int. Cl. G06Q 30/02

(52) U.S. Cl. CPC G06Q 30/0276; G06Q 30/0275; G06Q 30/0267

(57) ABSTRACT

A method and system for providing a one-click interface to a user for creating an advertisement instantly, and a method and system for a customer to respond to an advertisement. In particular, the method and system are suitable for receiving an input of information and settings related to the desired advertisement from a user and using a single click action to create the advertisement instantly. The one-click interface provides a simplistic approach for an unsophisticated user to easily create a promotion or advertisement in a short period of time and have the promotion or advertisement go live instantly. The method and system also support a more efficient solution for a customer to respond to an advertisement.

### CROSS-REFERENCE TO RELATED APPLICATION(S)

This application claims priority to U.S. Provisional Application 62/199,009, filed Jul. 30, 2015, U.S. Provisional Application 62/232,635, filed Sep. 25, 2015, and U.S. Provisional Application 62/311,186, filed Mar. 21, 2016 for all subject matter common to all applications. The disclosures of the provisional applications are hereby incorporated by reference in their entirety.

### FIELD OF THE INVENTION

The present invention relates to a novel technological solution enabling creation of an immediate promotional advertisement. In particular, the technological solution enables inputting information and settings related to the desired promotion and using a single click to create the promotion immediately. The present invention also provides a technological solution enabling one-click customer responses to a merchant that is the subject of the promotional advertisement.

### BACKGROUND

Generally, online and mobile advertising is growing rapidly due to the advent of mobile computing devices and widespread use of the internet. Accordingly, there is a growing desire for companies to advertise on the Internet and/or on mobile computing devices. However, current methodologies experience some shortcomings. Conventional online and mobile advertising systems are complicated, expensive, and tend to benefit large corporations and sophisticated users. These systems are not easy for the traditional user to utilize much less in an optimal manner. Specifically, for small business owners and entrepreneurs to compete with larger entities using conventional systems they often have to pay an advertising professional in addition to the advertising fees to get exposure on the web or on mobile devices. Accordingly, conventional advertising systems favor sophisticated advertisers with large advertising budgets. Additionally, traditional advertising services lack a simplistic approach for an unsophisticated user to easily create a promotion or advertisement in a short period of time and have the promotion or advertisement go live instantly in a highly relevant market audience.

Additionally, the conventional process for a customer to view a promotional advertisement and then reach out to the merchant that is the subject of the promotional advertisement often requires the customer user to view an advertisement, mentally or physically collect contact information, separately select a method of communication (e.g., telephone, text, email, etc.), separately initiate a process on a device implement the method of communication, and enter in the collected contact information to initiate a communication (and potentially enter additional inquiry information of the customer). The process can be cumbersome and difficult to manage in certain environments with certain devices, such as mobile phones with small keyboards and separate applications that are difficult or impossible to simultaneously display.

### SUMMARY

There is a need for an improved technological solution enabling an easy to use interface to create a promotional or advertising campaign without committing significant resources, time, and money, while targeting a desired audience of customer. There is additionally a need for improved technological solution enabling an easy to use customer interface that provides a customer user with the ability to respond to a promotional advertisement with a one-click action. The present invention is directed toward further solutions to address these needs, in addition to having other desirable characteristics. Specifically, the present invention provides a novel and unique technologically improved system enabling a one-click solution for creating and initiating a promotion or advertising campaign instantly, and with a high degree of relevance between the potential customer and the product or service. The present invention additional provides a novel and unique technologically improved one-click solution enabling a customer user to easily respond to a promotional advertisement.

In accordance with an embodiment of the present invention, a method for delivering a one-click-generated promotional advertisement to one or more mobile devices is provided. The method includes receiving, by a processor, a one-click submission of promotion criteria and content from a merchant user, the promotion criteria and content comprising geolocation criteria that defines a desired geolocation for the one or more mobile devices to be situated to receive distribution of a promotional advertisement, a mobile application criteria that defines desired mobile applications operating on the one or more mobile devices to receive distribution of the promotional advertisement, or both. The method also includes transforming, by a processor, the promotion criteria and content into the promotional advertisement and bidding on an ad impression available on the desired mobile applications operating on the one or more mobile devices through a plurality of ad exchanges for publication of the promotional advertisement, the bidding being in compliance with the promotion criteria and content. The method further includes receiving, from the plurality of ad exchanges, a winning bid confirmation for the ad impression, thereby transforming the one-click submission of promotion criteria and content into a confirmed ad impression approved for distribution as a promotional advertisement, and causing the plurality of ad exchanges to deliver the promotional advertisement within the ad impression to the one or more mobile devices without requiring additional input to the one-click submission of promotion criteria and content from the merchant user.

In accordance with aspects of the present invention, the promotion criteria and content further comprises budgeting constraints for distribution of the promotional advertisement. In accordance with aspects of the present invention, the budgeting constraints comprise a monetary budget cap based on a number of views of the promotional advertisement.

In accordance with aspects of the present invention, the promotional advertisement is delivered to at least one of the desired mobile applications executing on the one or more mobile devices instantly.

In accordance with aspects of the present invention, the further comprising registering the merchant user and creating a profile including predetermined criteria about the merchant user.

In accordance with aspects of the present invention, the bidding on the ad impression is for display of the promotional advertisement on the desired mobile applications within an ad network, outside of the ad network, or both.

In accordance with aspects of the present invention, the bidding further comprises utilizing at least one of contextual cues, keywords, and user demographics when bidding on which ad impressions to provide the promotional advertisement.

In accordance with aspects of the present invention, the one-click submission of promotion criteria and content further comprises one or two alpha-numeric lines entered by the merchant user to describe an offer to be displayed as part of the promotional advertisement.

In accordance with aspects of the present invention, the one-click submission of promotion criteria and content further comprises one of text ads or multimedia ads.

In accordance with aspects of the present invention, the method further includes generating reports containing historical data including a number of ad impressions of the promotional advertisement that appeared on the desired mobile applications, a number of clicks received in response to the promotional advertisement displayed, a listing of the desired mobile applications that the promotional advertisement was most frequently displayed, and an approximate geolocation of the one or more mobile devices that displayed the promotional advertisement within the desired mobile applications.

In accordance with aspects of the present invention, the promotional advertisement can be instantly re-launched in response to receiving a new one-click submission only. In accordance with aspects of the present invention, the new one-click submission comprises at least one of a selection of a one-click button, a short message service (SMS) message, or social media message.

In accordance with aspects of the present invention, the promotional advertisement comprises an automated event action caused to be executed on a customer user computing device when the promotional advertisement is selected on the customer user computing device. In accordance with aspects of the present invention, the automated event action caused to be executed on the customer user computing device comprises causing a webpage to open on a default web browser on the customer user computing device. In accordance with aspects of the present invention, the automated event action caused to be executed on the customer user computing device comprises causing a communication of a telephone number of the merchant user associated with the promotional advertisement to the customer user computing device and causing a telephone operation to occur on the customer user computing device for initiation of a telephone call to the telephone number.

In accordance with aspects of the present invention, the automated event action caused to be executed on the customer user computing device comprises causing a default email application on the customer user computing device to automatically open. In accordance with aspects of the present invention, the method further includes causing generation of a draft email, in the default email application, addressed to the merchant user associated with the promotional advertisement. In accordance with aspects of the present invention, the method further includes automatically populating suggested language in a body of the draft email.

In accordance with aspects of the present invention, the automated event action caused to be executed on the customer user computing device includes causing a default SMS application on the customer user computing device to automatically open, causing generation of a draft SMS text message, in the default SMS application, addressed to the merchant user associated with the promotional advertisement, and automatically populating suggested language in a body of the draft SMS text message. In accordance with aspects of the present invention, the method further includes comprising dynamically assigning temporary numbers from a set of temporary numbers to be associated with a sender and a recipient of the SMS text message.

In accordance with an embodiment of the present invention, a system for delivering a one-click-generated promotional advertisement to one or more mobile devices is provided. The system including an advertisement creator configured to receive a one-click submission of promotion criteria and content from a merchant user, the promotion criteria and content comprising geolocation criteria that defines a desired geolocation for the one or more mobile devices to be situated to receive a promotional advertisement distribution, a mobile application criteria that defines desired mobile applications operating on the one or more mobile devices to receive distribution of the promotional advertisement, or both. The system also including the advertisement creator configured to transform the promotion criteria and content into the promotional advertisement and a bidding mechanism configured to bid on an ad impression available on the desired mobile applications operating on the one or more mobile devices through a plurality of ad exchanges for publication of the promotional advertisement, the bidding being in compliance with the promotion criteria and content. The system further including the advertisement creator configured to receive, from the plurality of ad exchanges, a winning bid confirmation for the ad impression, thereby transforming the one-click submission of promotion criteria and content into a confirmed ad impression approved for distribution as a promotional advertisement, and causing the plurality of ad exchanges to deliver the promotional advertisement within the ad impression to the one or more mobile devices without requiring additional input to the one-click submission of promotion criteria and content from the merchant user.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of a system for implementing processes in accordance with aspects of the invention;

FIG. 2 is a representative flowchart of a process of a user creating an advertisement or promotion using a one-click submission in accordance with aspects of the invention;

FIG. 3 is a representative flowchart of a process of creating an advertisement or promotion in response to receiving a one-click submission in accordance with aspects of the invention; and

FIG. 4 is a diagrammatic illustration of a high level architecture for implementing processes in accordance with aspects of the invention.

### DETAILED DESCRIPTION

An illustrative embodiment of the present invention relates to a technologically improved system and method providing a self-service advertising service with one-click functionality. The self-service advertising service provides a unique approach to provide online advertising and specifically advertising on mobile applications. In particular, a merchant user can use the self-service advertising service to create and activate an advertising campaign or promotion using a one-click interface. A merchant user can visit a webpage for the self-service advertising service or download a mobile application for the self-service advertising service to create their advertisement. The user interface, on the webpage or on the mobile application, includes a simple sign in process, a plurality of fields and/or selections to provide content for the advertisement or promotion, a payment method, and the one-click button to launch the advertisement or promotion using the provided content. After the one-click button has been selected by the merchant user, the advertisement or promotion will in real-time be created and pushed over one or more advertising exchange networks and presented to potential customers in a highly targeted manner. The advertisement promotion can include various features, such as causing an event action to occur when a potential customer clicks on or selects a displayed advertisement or promotion. The event action can include causing the automatic opening of a webpage on the default web browser on the customer's device, causing initiation of a telephone operation to occur on the customer's device with telephone number populated automatically, and/or causing the automatic opening of a default email application on the customer's device and generation of a draft email addressed to the merchant user associated with the advertisement or promotion, including populating suggested language in a body of the email.

The self-service advertising service enables small business owners and entrepreneurs to compete with larger corporations to get their advertising and promotions displayed to potential customers. Merchant users are able to use the service to quickly create a customize advertisement or promotion to be displayed to their potential target customers. The self-service advertising service utilizes a combination of big data and geo location in combination with an easy to use one-click implemented interface to produce an online advertising campaign to provide the advertisement or promotion to the potential target customers. Specifically, the self-service advertising service scans through available ad inventory across a plurality of advertising networks and utilizes real-time bidding technology to obtain the best advertising space for the merchant user. Additionally, the use of geolocation technologies allows a merchant user to target advertising to a specific area or a range of areas. These components used in combination with the easy to use one-click interface allow a merchant user to quickly create an advertising campaign with the push of a single button.

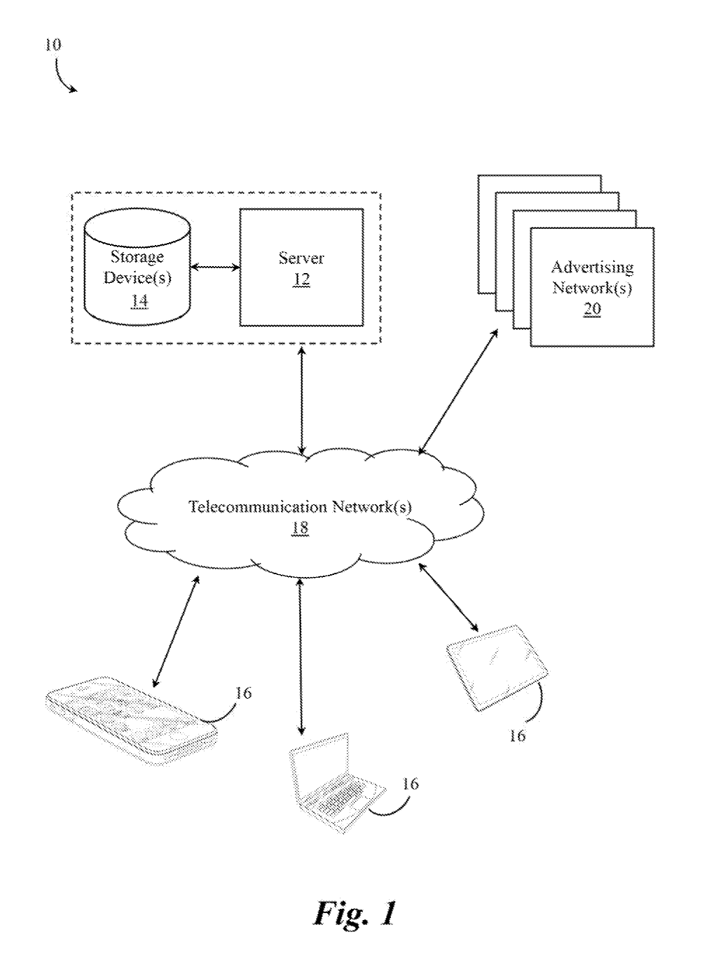

FIGS. 1 through 4, wherein like parts are designated by like reference numerals throughout, illustrate an example embodiment or embodiments of one-click creation of a promotional or advertisement campaign, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed in a manner still in keeping with the spirit and scope of the present invention.

FIG. 1 depicts a diagrammatic illustration of a system 10 for implementing processes in accordance with aspects of the invention. The system 10 includes a server 12 that includes or is otherwise in communication with a storage device(s) 14. As would be appreciated by one skilled in the art, the server 12 can be a computing device having a database (e.g., storage device(s) 14). As would be appreciated by one skilled in the art, the server 12 may be a general purpose computer or a specialized computer system. For example, the server 12 may include a single computing device, a collection of computing devices in a network computing system, a cloud computing infrastructure, or a combination thereof, as would be appreciated by those of skill in the art. Similarly, as would be appreciated to one of skill in the art, the storage device(s) 14 can include any combination of computing devices configured to store and organize a collection of data. For example, the storage device(s) 14 can be a local storage device on the server 12, a remote database facility, or a cloud computing storage environment. The storage device(s) 14 can also include a database management system utilizing a given database model configured to interact with a user for analyzing the database data.

In operation, the server 12 is provides a self-service advertising service to merchant users. The one or more user computing device(s) 16 can include any combination of a merchant user device that desires to publish an ad or promo and one or more potential target customers to receive the merchant user's advertisement or promo motion. The server 12 is also operable to communicate with one or more user computing device(s) 16. As would be appreciated by one skilled in the art, the one or more user computing device(s) 16 can include general purpose computer or a specialized computer systems including mobile phones, smartphones, laptops, desktop computers, tablets, etc. The server 12 and one or more user computing device(s) 16 can be configured to communicate with one another and exchange data over a telecommunication network(s) 18. As would be appreciated by one of skill in the art, the telecommunication network(s) 18 may include any combination of known networks. For example, the telecommunication network(s) 18 may be combination of a mobile network, the Internet, WAN, LAN, or other type of network. The telecommunication network(s) 18 may be used to exchange data between the server 12 and the one or more user computing device(s) 16, exchange data with the storage device(s) 14 (e.g., in a cloud environment), and/or to collect data from additional sources.

Similarly, the server 12 can be configured to communicate with a plurality of advertising networks or ad exchanges 20 over the telecommunication network(s) 18. The plurality of ad exchanges 20 can include a combination of computing devices operating over multiple different advertising networks. The server 12 and the plurality of ad exchanges 20 can be configured to exchange data related to bidding on available advertising space and data related to advertisements to be published in the available advertising space.

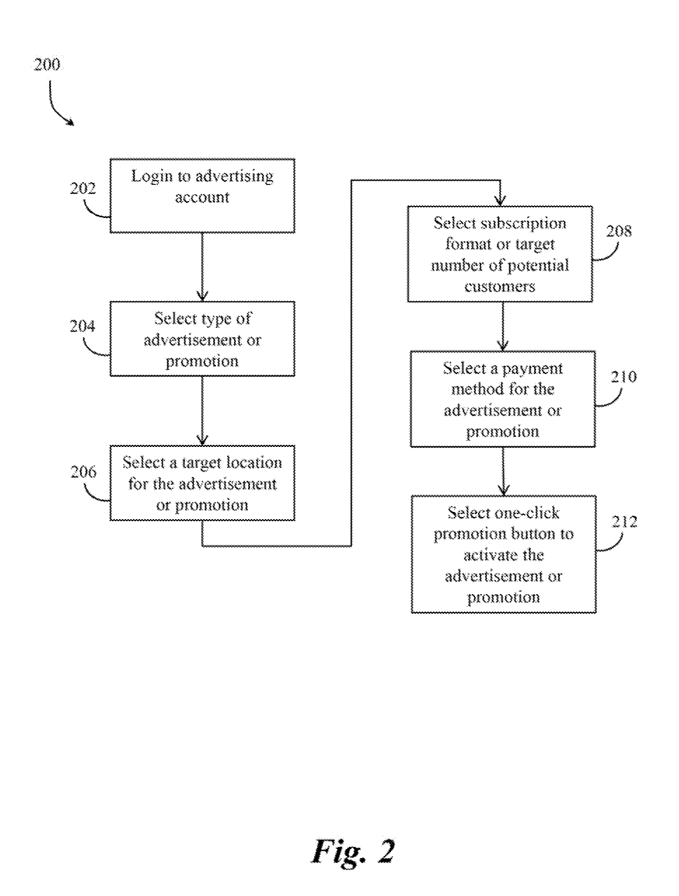

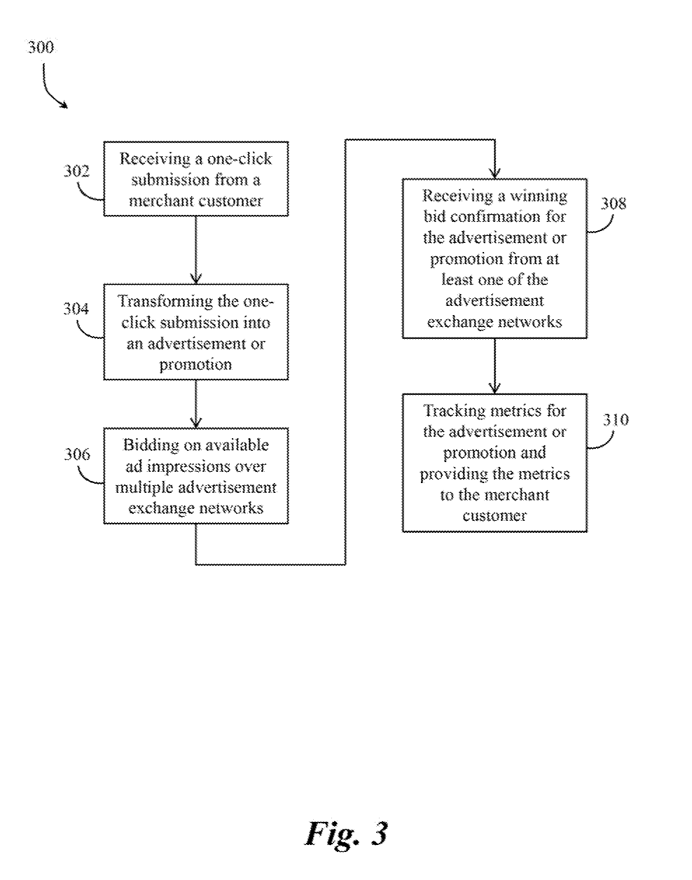

FIGS. 2 and 3 show exemplary flow charts depicting implementation of the present invention. Specifically, FIG. 2 depicts an exemplary flow chart showing a process 200 of a user creating an advertisement or promotion in accordance with aspects of the invention. At step 202, the server 12 provides a user interface for the merchant user to login to an advertising account (e.g., the one or more user computing device(s) 16). The merchant user can login into their previously created account. As would be appreciated by one skilled in the art, the merchant user can sign into the service using a user name and password. The previously created user account can be a user account previously registered with the service provider. As would be appreciated by one skilled in the art, the user account can include a profile including predetermined criteria about the merchant user associated with the login information. Additionally, the profile can include a combination of required and optional information. For example, the merchant user may be required to have billing information saved in their profile to expedite the one-click ad creation functionality. Similarly, the merchant user may optionally have additional profile information stored in their profile, such as advertising template or promotional content, business address, business demographic data, payment methods, historical data, etc. As would be appreciated by one skilled in the art, the user profiles and related content can be stored on server 12 and the one or more user computing device(s) 16.

At step 204, the server 12 provides a user interface for selecting a type of advertisement or promotion. The step of selecting the type of advertisement can include criteria related to text and/or multimedia to include in advertisement or promotion. The type of advertisement can also include filling in identifiable content fields used by the service provider to create the advertisement or promotion. The fields can include a heading field for the advertisement or promotional title, a description field for including a two or three sentence description for the advertisement for the promotion, and an optional action link field for entering a web address or profile page. For example, a merchant user can enter their company title, “Mario's Pizza” and a description for their promo, “Buy one get one free pizza! Tonight only . . . ”. As would be appreciated by one skilled in the art, the user interface can also allow a merchant user to upload a pre-existing advertisement or promotion to the server 12 through the user interface. The pre-existing advertisement or promotion can include textual, graphical, video, audio, and/or any combination of multimedia. Additionally, the selecting the type of advertisement or promotion can also include selecting the mobile applications where the merchant would like to advertise. The user interface can display a list of available mobile applications (e.g., news apps, gaming apps, social media app, searching apps, etc.) to the merchant user and receive a selection of the desired mobile applications that the merchant user wants to advertise on. As would be appreciated by one skilled in the art, the selection of desired applications can include a selection of a genre of applications or a selection of specific applications.

In accordance with an example embodiment of the present invention, selecting a type of advertisement or promotion (step 204) can include selecting an event action that the merchant user wants to have occur when a potential customer clicks on or selects a displayed advertisement or promotion. The event action can include causing the automatic opening of a webpage on the default web browser on the customer's computing device 16 (e.g., the merchant user's website), causing the automatic communicating of a telephone number to customer's computing device 16 and causing a telephone operation to occur on the customer's computing device 16 for the customer user to initiate a call to the merchant user associated with the advertisement or promotion, or causing the automatic opening of a default email or short message service (SMS) application on the customer's computing device 16 and generation of a draft email or SMS message addressed to the merchant user associated with the advertisement or promotion, including populating suggested language in a body of the email or SMS message.

In accordance with an example embodiment of the present invention, the mailto protocol (mailto uniform resource identifier (URI) scheme, as registered with the Internet Assigned Numbers Authority (IANA)) can be utilized to automatically open and generate the draft email using data from the advertisement or promotion. As would be appreciated by one skilled in the art, the system 10 causes the generation of a draft email and can cause the automated population of the body of the email with metadata sent to the customer's computing device 16 in response to the customer clicking the advertisement or promotion. For example, information about the merchant user and the particular advertisement or promotion can be sent to the customer's computing device 16 and used in generating a draft email on the customer's computing device 16 in response to clicking the advertisement or promotion. Accordingly, the target email address, the subject line, and the body of the email can all be automatically populated with a generic response without additional input from the customer. For example, target email address can be populated with the advertiser's email address, the subject line can be populated with “Request for Information: Instant+Local+Mobile+Ads”, the body can be populated with “Hello, I am interested in more information about your advertisement for: Instant+Local+Mobile+Ads, Thank You.” The customer can decide whether to send the draft email unchanged, modify the draft email and send the email, or discard the email draft. The emails received by the merchant user from potential customers can be used for lead generation in future advertisements and promotions.

As would be appreciated by one skilled in the art, the target email address can be addressed to the service provider's email address (e.g., the email address associated with server 12), the draft email can be addressed directly to the merchant user's desired email address, or both. In the instances that the draft email is addressed to the service provider's email address, the server 12 will automatically transmit the original or modified summarized email message to the merchant user (e.g., via email, an application, and/or updated on the merchants advertising account). When the draft email is addressed directly to the merchant user, the draft email can optionally include a Carbon Copy (CC) or Blind Carbon Copy of the drat email addressed to service provider's email address.

In accordance with an example embodiment of the present invention, the event action causing the automatic opening of a default SMS application on the customer's computing device 16 and generation of a draft SMS text message is performed by a SMS protocol. The SMS protocol is configured to create the default SMS text message addressed to the merchant user associated with the advertisement or promotion, including populating suggested language in a body of the SMS text message. In accordance with an example embodiment of the present invention, in response to a user selecting the event action for the SMS text message, the system 10 dynamically assigns temporary numbers from a set of temporary numbers to be associated with the sender and recipient of the SMS text message. By providing the temporary numbers, the real contact numbers for the parties will not be disclosed to one another.

In accordance with an example embodiment of the present invention, the selection of an event that occurs when a potential customer clicks on or selects a displayed advertisement or promotion can include a combination of events. For example, a user can click a portion of the advertisement labeled “Call Now” to initiate a call event or the potential customer can click on another portion of the advertisement to initiate loading the merchant user's website. In accordance with an example embodiment of the present invention, in response to a user selecting the event (e.g., the “Call Now” button), the system 10 dynamically assigns a number from a set of temporary numbers to be used to forward the call to the advertiser. By providing the temporary number, the real contact numbers for the parties will not be disclosed to one another. As would be appreciated by one skilled in the art, temporary numbers can be assigned to either or both parties.

At step 206, the merchant user selects a geolocation in the form of a target location for the advertisement or promotion, by selecting a location or radius for displaying the advertisement or promotion. The merchant user can select a town, a radius, a zip code, or a distance around one of these criteria for displaying their advertisement or promotion. For example, the merchant user can select for their promotion to be displayed to potential customers within a 10 mile radius of the address for their establishment. Additionally, the location of the merchant user can use a Global Positioning System (GPS) from the one or more user computing device(s) 16. The location information obtained from the GPS can be used to establish the center of the radius to be utilized for distributing the advertisement or promotion.

At step 208, the merchant user selects subscription format and/or targeted number of potential customers, which translates to providing budget constraints for the advertisement or promotion distribution. The budget constraints can include a monetary budget cap based on a number of views of the promotional advertisement, a subscription format for a time period, or target number of potential merchant users. The desired subscription can include predetermined subscription packages created by the service provide or can include a customized format. For example, the merchant user can select a number of potential merchant user views that they want to pay for (e.g., 1,000 views) or for a duration (e.g., 1 month). The budgetary constraints will dictate how many times and/or how long the advertisement or promotion is displayed to other users.

At step 210, the merchant user selects a payment method on the user interface. The selection of the payment method can include selecting a previously saved payment method from a list of potential payment methods or can include a number of fields to enter the payment information. The previously saved payment method can be stored in the user profile as a method of payment previously entered by the merchant user. As would be appreciated by one skilled in the art, the merchant user can select and/or enter a variety of different payment methods. For example, the merchant user can pay using PayPal, a credit card, digital currency, bank account information, etc. Additionally, the user interface can provide fields for entering a new payment method.

At step 212, the merchant user selects a one-click promotion button to activate the advertisement or promotion. Selection of the one-click button causes the server 12 to use the various promotion criteria and content provided in steps 202-210 to automatically create and initiate the advertising and promotion campaign. The steps associated with the server 12 creating and initiating the advertisement or promotion are discussed in greater detail with respect to FIG. 3.

FIG. 3 depicts an exemplary flow chart showing a process 300 of creating an advertisement or promotion in response to a user's one-click submission, in accordance with aspects of the invention. At step 302, the server 12 receives a one-click submission of promotion criteria and content from a merchant user (e.g., the one or more user computing device(s) 16). The one-click submission is received in response to the merchant user logging into the server 12 and supplying the promotional criteria and content, as discussed with respect to FIG. 2. The promotion criteria and content can include any advertising content received from the merchant user in the form of text, graphics, audio, video, etc. The promotion criteria and content can also include geolocation criteria that defines a desired geolocation for the one or more user computing device(s) 16 desired to receive a promotional advertisement distribution, as discussed with respect to FIG. 2. The promotional criteria and content can also include mobile application criteria that defines desired mobile applications operating on the one or more mobile devices to receive the promotional advertisement distribution.

At step 304, the server 12 transforms the promotion criteria and content received from the one-click submission into the promotional advertisement. As would be appreciated by one skilled in the art, the step of transforming can include taking the data obtained from the promotion criteria and content (e.g., the fields populated by the merchant user as discussed with respect to FIG. 2) and generating an advertisement or promotion to fit an advertisement space using methods known in the art. For example, the text from the promotion criteria and content can be entered into an advertisement template suitable for advertisement display. Similarly, the server 12 can transform the merchant advertisement or promotion submission into a format suitable for display in an available advertisement space(s).

At step 306, the server 12 bids on available ad impression space through a plurality of ad exchange networks for publication of the advertisement or promotion. The bidding is performed based on the budgetary constraints, promotion criteria, and content provided by the merchant user (e.g., in FIG. 2). The bidding process can also utilize a combination of big data and location information to determine which users to target. In accordance with an example embodiment, the server 12 can pull geolocation of mobile devices (e.g., the one or more user computing device(s) 16) associated with the plurality of ad exchange networks. The big data and location information can be used by the server 12 to determine whether those mobile devices fall within an acceptable range for the advertisement or promotion location criteria submitted by the merchant user. For example, the server 12 can bid on an ad space within a desired mobile application operating on the one or more user computing device(s) 16 located within the geographical criteria. The bidding on the ad impression can be for the display of the promotional advertisement on the desired websites or mobile applications within an ad network, outside of the ad network, or both. Additionally, the bidding can also utilize at least one of contextual cues, keywords, and user demographics when bidding on which ad impressions to provide the promotional advertisement while using traditional bidding methodologies. Accordingly, the bidding and display of the advertisement or promotion is not limited to a single advertising network, but utilizes available advertising slots over a plurality of different advertising networks.

At step 308, the server 12 receives a winning bid confirmation for the ad impression from at least one of the plurality of ad exchanges 20. The winning bid confirmation provides identifying information for the one-click submission of promotion criteria into a confirmed ad impression for distribution as a promotional advertisement, and causing the one or more ad exchange networks to deliver the promotional advertisement within the ad impression to the one or more mobile devices without requiring additional input to the one-click submission from the merchant user. As would be appreciated by one skilled in the art, the result of winning a bid enables the advertisement to be displayed in the ad space(s) associated with the bid as well as access to information related to the ad space(s).

At step 310, the server 12, in combination with the plurality of ad exchanges 20 running the advertisement or promotion, tracks metrics for the advertisement or promotion and provides the metrics to the merchant customer. As would be appreciated by one skilled in the art, the metrics can include a number data points showing the merchant user the effectiveness of the advertisement or promotion. For example, the metrics can provide a number of views of the advertisement or promotion, the number of page visits resulting from the views, a number of email submissions received in response to the displayed promotional advertisement, and a budget status for the merchant's current advertising campaign. Additionally, the server 12 can provide the merchant user with an interface to view how the advertisement or promotion is being distributed in real time. For example, the merchant user can use their login information (as discussed with respect to FIG. 2) to view their information in real time, view historical data, or other metrics. The server 12 is also operable to generate reports containing historical data including a number of the ad impressions of the promotional advertisement that appeared on the desired mobile applications, a number of clicks received in response to the displayed promotional advertisement, a listing of the desired mobile applications that the promotional advertisement was most frequently displayed, a number of email submissions received in response to the displayed promotional advertisement, and an approximate geolocation of the one or more mobile devices that displayed the promotional advertisement within the desired mobile applications. The merchant user can also login to the server 12 to view historical data for past advertisements and compare performances against current advertisements or promotions.

In addition to tracking metrics, the server 12 can also monitor the budgetary constraints for each running advertisement or promotion. Accordingly, once the duration and/or number of views of the advertisement or promotion has been met (e.g., after 1,000 views or after 1 month), the advertisement or promotion is terminated and is no longer displayed. As would be appreciated by one skilled in the art, terminated advertisements and promotions can be saved and re-activated later by the merchant user.

In accordance with an example embodiment of the present invention, once a merchant user has completed the initial setup for a particular advertisement or promotion, a one-click promotional functionality is enabled. The one-click promotional functionality enables future iterations of that particular advertisement to be created and activated by a single submission, (e.g., selecting the one-click button). The merchant user can simply use the one-click button feature to send a submission to the server 12, requesting the server 12 re-launch a previously created advertisement or promotion campaign. With the advertisement or promotion information and payment info already stored in the storage device(s) 14 for the server 12, the advertisement or promotion can go live instantly.

In accordance with an example embodiment of the present invention, when the one-click promotional functionality is enabled, the merchant user can instantly initiate a pre-existing advertisement or promotion campaign with a single action submission. As discussed herein with respect to FIGS. 2 and 3, the single action can include selecting and/or clicking on a single “one-click promo” button in a user interface. As would be appreciated by one skilled in the art, the single action submission can also include methods. For example, the single action submission can include sending a submission message over SMS to a number or temporarily assigned number associated with a service provider running the server 12, or sending a submission message over social media formats (e.g., a tweet or post to the service provider). Once a submission message is received, the server 12 can initiate launching the existing advertisement or promotion using the steps as described in FIG. 3.

In accordance with an example embodiment of the present invention, the server 12 can launch the existing advertisement or promotion using the information in the original submission, or the server 12 can modify the advertisement or promotion to include additional information obtained from the single action/one-click submission. The additional information can be obtained through the single action submission itself (e.g., text included in the SMS or tweet) or the server 12 can obtain the information automatically (e.g., using GPS of the submission device). For example, the additional information can be obtained from a tweet from a merchant user, through a one-click submission, to the service provider, in a predetermined format of @ServiceProvider <field1:value-a> <field-2:value-b> . . . <field-n:value-z>. As an illustrative example, this can be implemented as follows: @Cidewalkapp CMP 123, ZIP 01545, BDGT: $100 (i.e., text truncation for @SERVICE PROVIDER CAMPAIGN ID 123, LOCATION ZIP CODE 01545, BUDGET LIMIT $100). The server 12 can parse the information from the fields in the tweet and determine that the advertisement or promotion associated with identifier (ID) number 123 should be re-launched in a zip code 01545 with a budget limited to $100. As would be appreciated by one skilled in the art, information not included in the one-click submission can default to the original information for that advertisement or promotion. Similarly, the server 12 can also infer changes to the advertisement or promotion. For example, the server 12 can determine that the one-click submission is received from a device located at a particular location (e.g., using GPS of the submission device) and use that location as the radius for publishing the advertisement or promotion.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

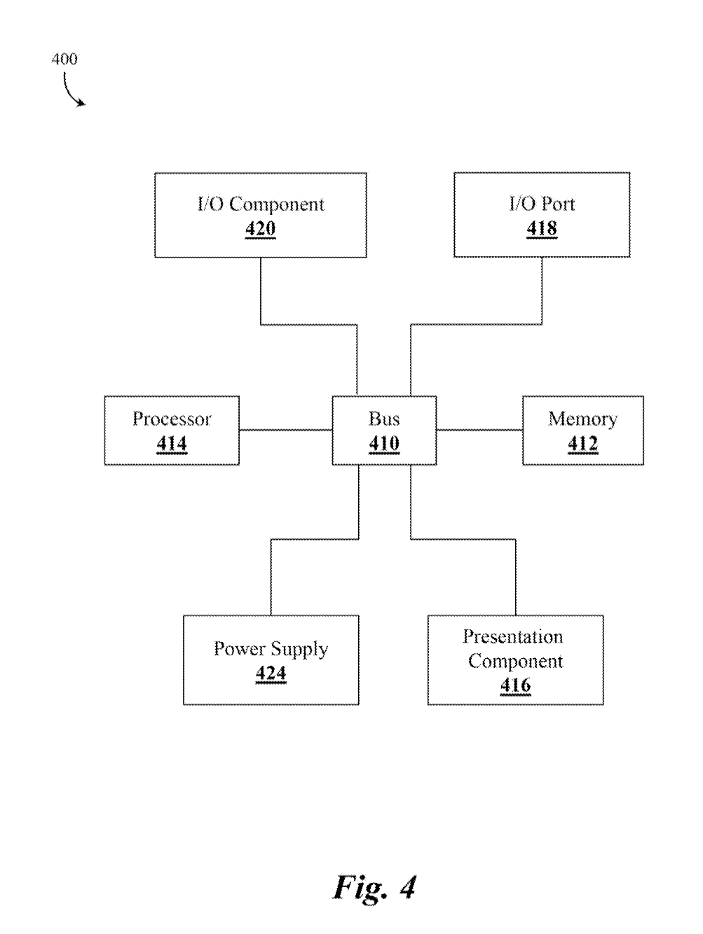

Any suitable computing device can be used to implement the computing devices 12, 14, 16 and methods/functionality described herein. One illustrative example of such a computing device 400 is depicted in FIG. 4. The computing device 400 is merely an illustrative example of a suitable computing environment and in no way limits the scope of the present invention. A “computing device,” as represented by FIG. 4, can include a “workstation,” a “server,” a “laptop,” a “desktop,” a “hand-held device,” a “mobile device,” a “tablet computer,” or other computing devices, as would be understood by those of skill in the art. Given that the computing device 400 is depicted for illustrative purposes, embodiments of the present invention may utilize any number of computing devices 400 in any number of different ways to implement a single embodiment of the present invention. Accordingly, embodiments of the present invention are not limited to a single computing device 400, as would be appreciated by one with skill in the art, nor are they limited to a single type of implementation or configuration of the example computing device 400.

The computing device 400 can include a bus 410 that can be coupled to one or more of the following illustrative components, directly or indirectly: a memory 412, one or more processors 414, one or more presentation components 416, input/output ports 418, input/output components 420, and a power supply 424. One of skill in the art will appreciate that the bus 410 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 4 is merely illustrative of an exemplary computing device that can be used to implement one or more embodiments of the present invention, and in no way limits the invention.

The computing device 400 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 400.

The memory 412 can include computer-storage media in the form of volatile and/or nonvolatile memory. The memory 412 may be removable, non-removable, or any combination thereof. Exemplary hardware devices are devices such as hard drives, solid-state memory, optical-disc drives, and the like. The computing device 400 can include one or more processors that read data from components such as the memory 412, the various I/O components 416, etc. Presentation component(s) 416 present data indications to a user or other device. Exemplary presentation components include a display device, speaker, printing component, vibrating component, etc.

The I/O ports 418 can enable the computing device 400 to be logically coupled to other devices, such as I/O components 420. Some of the I/O components 420 can be built into the computing device 400. Examples of such I/O components 420 include a microphone, joystick, recording device, game pad, satellite dish, scanner, printer, wireless device, networking device, and the like.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method for delivering a one-click-generated promotional advertisement to one or more mobile devices, the method comprising:
receiving, by a processor, a one-click submission of promotion criteria and content from a merchant user, the promotion criteria and content comprising geolocation criteria that defines a desired geolocation for the one or more mobile devices to be situated to receive distribution of a promotional advertisement, a mobile application criteria that defines desired mobile applications operating on the one or more mobile devices to receive distribution of the promotional advertisement, or both;
transforming, by a processor, the promotion criteria and content into the promotional advertisement;
bidding on an ad impression available on the desired mobile applications operating on the one or more mobile devices through a plurality of ad exchanges for publication of the promotional advertisement, the bidding being in compliance with the promotion criteria and content; and
receiving, from the plurality of ad exchanges, a winning bid confirmation for the ad impression, thereby transforming the one-click submission of promotion criteria and content into a confirmed ad impression approved for distribution as a promotional advertisement, and causing the plurality of ad exchanges to deliver the promotional advertisement within the ad impression to the one or more mobile devices without requiring additional input to the one-click submission of promotion criteria and content from the merchant user.

2. The method of claim 1, wherein the promotion criteria and content further comprises budgeting constraints for distribution of the promotional advertisement.

3. The method of claim 2, wherein the budgeting constraints comprise a monetary budget cap based on a number of views of the promotional advertisement.

4. The method of claim 1, wherein the promotional advertisement is delivered to at least one of the desired mobile applications executing on the one or more mobile devices instantly.

5. The method of claim 1, further comprising registering the merchant user and creating a profile including predetermined criteria about the merchant user.

6. The method of claim 1, wherein the bidding on the ad impression is for display of the promotional advertisement on the desired mobile applications within an ad network, outside of the ad network, or both.

7. The method of claim 1, wherein the bidding further comprises utilizing at least one of contextual cues, keywords, and user demographics when bidding on which ad impressions to provide the promotional advertisement.

8. The method of claim 1, wherein the one-click submission of promotion criteria and content further comprises one or two alpha-numeric lines entered by the merchant user to describe an offer to be displayed as part of the promotional advertisement.

9. The method of claim 1, wherein the one-click submission of promotion criteria and content further comprises one of text ads or multimedia ads.

10. The method of claim 1, further comprising generating reports containing historical data including a number of ad impressions of the promotional advertisement that appeared on the desired mobile applications, a number of clicks received in response to the promotional advertisement displayed, a listing of the desired mobile applications that the promotional advertisement was most frequently displayed, and an approximate geolocation of the one or more mobile devices that displayed the promotional advertisement within the desired mobile applications.

11. The method of claim 1, wherein the promotional advertisement can be instantly re-launched in response to receiving a new one-click submission only.

12. The method of claim 11, wherein the new one-click submission comprises at least one of a selection of a one-click button, a short message service (SMS) message, or social media message.

13. The method of claim 1, wherein the promotional advertisement comprises an automated event action caused to be executed on a customer user computing device when the promotional advertisement is selected on the customer user computing device.

14. The method of claim 13, wherein the automated event action caused to be executed on the customer user computing device comprises causing a webpage to open on a default web browser on the customer user computing device.

15. The method of claim 13, wherein the automated event action caused to be executed on the customer user computing device comprises causing a communication of a telephone number of the merchant user associated with the promotional advertisement to the customer user computing device and causing a telephone operation to occur on the customer user computing device for initiation of a telephone call to the telephone number.

16. The method of claim 13, wherein the automated event action caused to be executed on the customer user computing device comprises causing a default email application on the customer user computing device to automatically open.

17. The method of claim 16, further comprising causing generation of a draft email, in the default email application, addressed to the merchant user associated with the promotional advertisement.

18. The method of claim 17, further comprising automatically populating suggested language in a body of the draft email.

19. The method of claim 13, wherein the automated event action caused to be executed on the customer user computing device comprises:
causing a default SMS application on the customer user computing device to automatically open;
causing generation of a draft SMS text message, in the default SMS application, addressed to the merchant user associated with the promotional advertisement; and
automatically populating suggested language in a body of the draft SMS text message.

20. The method of claim 19, further comprising dynamically assigning temporary numbers from a set of temporary numbers to be associated with a sender and a recipient of the SMS text message.

21. A system for delivering a one-click-generated promotional advertisement to one or more mobile devices, the system comprising:
an advertisement creator configured to receive a one-click submission of promotion criteria and content from a merchant user, the promotion criteria and content comprising geolocation criteria that defines a desired geolocation for the one or more mobile devices to be situated to receive a promotional advertisement distribution, a mobile application criteria that defines desired mobile applications operating on the one or more mobile devices to receive distribution of the promotional advertisement, or both;
the advertisement creator configured to transform the promotion criteria and content into the promotional advertisement;
a bidding mechanism configured to bid on an ad impression available on the desired mobile applications operating on the one or more mobile devices through a plurality of ad exchanges for publication of the promotional advertisement, the bidding being in compliance with the promotion criteria and content; and
the advertisement creator configured to receive, from the plurality of ad exchanges, a winning bid confirmation for the ad impression, thereby transforming the one-click submission of promotion criteria and content into a confirmed ad impression approved for distribution as a promotional advertisement, and causing the plurality of ad exchanges to deliver the promotional advertisement within the ad impression to the one or more mobile devices without requiring additional input to the one-click submission of promotion criteria and content from the merchant user.
